(19) United States
(12) Patent Application Publication
(10) Pub. No.: US 2017/0158202 A1
(43) Pub. Date: Jun. 8, 2017

(54) DRIVER BIOMETRIC INFORMATION SIGNAL MEASUREMENT SYSTEM AND METHOD

(71) Applicant: Sun Jong YANG, Seongnam-si (KR)

(72) Inventor: Sun Jong YANG, Seongnam-si (KR)

(21) Appl. No.: 15/367,843

(22) Filed: Dec. 2, 2016

(30) Foreign Application Priority Data
Dec. 3, 2015 (KR) 10-2015-0171110

(51) Int. Cl. B60W 40/08

(52) U.S. Cl. CPC B60W 40/08; B60W 2040/0818

(57) ABSTRACT

Disclosed are a driver biometric information signal measurement system and a method of measuring driver biometric information signals in which biometric information signals of a driver are measured and whether or not a driver's biometric abnormality event occurs is judged therethrough so as to provide safe driving of the driver. An ultra-wideband communication sensor unit measures biometric information signals of the driver in real time by transmitting an ultra-wideband impulse radio signal, and a wearable device measures additional biometric information signals of the driver under designated conditions, i.e., contact and non-contact biometric information signals of the driver are measured, thereby securing safe driving of the driver if a driver's biometric abnormality event occurs.

### CROSS-REFERENCE TO RELATED APPLICATION

This application claims under 35 U.S.C. §119(a) the benefit of priority to Korean Patent Application No. 10-2015-0171110 filed on Dec. 3, 2015, the entire contents of which are incorporated herein by reference.

### BACKGROUND

(a) Technical Field

The present disclosure relates to a system which measures biometric information signals of a driver through a vehicle including an ultra-wideband communication sensor. More particularly, it relates to a driver biometric information signal measurement system and method in which biometric information signals of a driver are accurately measured through an ultra-wideband communication impulse radar and a wearable device and then noise is removed from the measured biometric information signals.

(b) Background Art

As efforts to enhance both driving performance and driving stability of vehicles are continued, technologies for enhancing driver's stability, such as reduction of vibration of a steering wheel according to lane change of a vehicle, are being applied to the inside of the vehicle. Further, technologies for enhancing driver-focused stability of vehicles as well as technologies for enhancing driver's stability during driving of vehicles are discussed now.

As the above technologies for enhancing driver-focused stability of vehicles, technologies for judging whether or not a driver is biologically abnormal become an issue.

However, if a non-contact measurement method is used to measure biometric information of a driver, it is difficult to accurately measure the information due to noise generated from a vehicle, and if a contact measurement method is used, such a contact measurement method may not satisfy all drivers' tendencies.

As prior art, Korean Patent Laid-open Publication No. 10-2014-0106303 (hereinafter, referred to as document 1) discloses technology for transmitting and receiving an accident state of a vehicle, a vehicle accident spot, information on a driver, etc., if a vehicle accident occurs.

However, document 1 provides only a video recording system for vehicles which rapidly deals with a vehicle accident after the accident and does not provide technologies for measuring abnormality of the driver's biometric information during driving.

Further, document 1 does not provide technologies for correcting measured body information due to vibration and noise generated from the vehicle and thus have difficulty in accurate measurement of driver's biometric information.

### SUMMARY OF THE DISCLOSURE

The present invention has been made in an effort to solve the above-described problems associated with the prior art and it is an object of the present invention to provide technology that measures biometric information signals of a driver during driving and judges whether or not a driver's biometric abnormality occurs therethrough so as to ensure safe driving of the driver, and measures driver's body contact and non-contact biometric information signals through an ultra-wideband communication sensor unit of a control module located in a vehicle and a wearable device.

In one aspect, the present invention provides a driver's biometric information signal measurement system including a control module located in a vehicle, the control module including an ultra-wideband communication sensor unit located within the vehicle, a storage unit configured to store biometric information signals measured by the ultra-wideband communication sensor unit, and a noise removal unit configured to correct the stored biometric information signals according to vibration of the vehicle, wherein the ultra-wideband communication sensor unit judges whether or not a passenger gets in the vehicle, judges whether or not the passenger is a driver of the vehicle and measures non-contact type biometric information signals of the driver upon judging that the passenger is the driver, and a wearable device configured to measure additional contact type biometric information signals of the driver when the biometric information signals of the driver measured by the ultra-wideband communication sensor unit are outside biometric information data ranges set in advance in the storage unit.

In a preferred embodiment, the ultra-wideband communication sensor unit may include a transmitter unit configured to transmit an ultra-wideband impulse radio signal, a receiver unit configured to receive a signal reflected by the driver's body, and a response analysis unit configured to analyze biometric information from the received signal. In another preferred embodiment, the noise removal unit may calculate a correction value according to vibration of the vehicle through a vibration sensor, an acceleration sensor and a noise sensor located in the vehicle and correct the measured biometric information signals through the calculated correction value.

In still another preferred embodiment, the ultra-wideband communication sensor unit may measure at least one of heartbeat information, non-contact respiratory information and movement information of the driver.

In yet another preferred embodiment, the wearable device may be formed in any one of a wristband type, a glasses type and a ring type.

In still yet another preferred embodiment, the additional biometric information signals measured by the wearable device may include at least one of heartbeat information, body temperature information, blood sugar information, pupillary change information, blood pressure information, blood alcohol information and a dissolved oxygen content in blood.

In a further preferred embodiment, the wearable device may interwork with a mobile device through short-range communication, and transmit a biometric abnormality event message to a predetermined server or receiver through short-range communication, when the additional biometric information signals are outside biometric information data ranges set in advance in the storage unit.

In another further preferred embodiment, if it is judged that an abnormality event of the measured driver biometric information signals occurs, the control module may execute at least one of restriction of the speed of the vehicle, blinking of emergency lights of the vehicle and guidance of parking of the vehicle.

In still another further preferred embodiment, the ultra-wideband communication sensor unit may set a security mode of the vehicle according to any one of stopping of the vehicle, turning-off of starting of the vehicle and user setting.

In another aspect, the present invention provides a driver biometric information signal measurement method including judging, by an ultra-wideband communication sensor unit located in a vehicle, whether or not a passenger gets in the vehicle and judging whether or not the passenger is a driver of the vehicle, measuring, by the ultra-wideband communication sensor unit, biometric information signals of the driver upon judging that the passenger is the driver, storing the measured biometric information signals of the driver in a storage unit, correcting, by a noise removal unit, the stored biometric information signals according to vibration of the vehicle, and measuring, by a wearable device, additional biometric information signals of the driver, if the driver's biometric information signals measured by the ultra-wideband communication sensor unit are outside biometric information data ranges set in advance in the storage unit.

In a preferred embodiment, measurement of the driver biometric information signals by the ultra-wideband communication sensor unit may include transmitting, by a transmitter unit, a ultra-wideband impulse radio signal, receiving, by a receiver unit, a signal reflected by the driver's body, and analyzing, by a response analysis unit, biometric information from the received signal.

In another preferred embodiment, the noise removal unit may calculate a correction value according to vibration of the vehicle through a vibration sensor, an acceleration sensor and a noise sensor located in the vehicle and correct the measured biometric information signals through the calculated correction value.

In still another preferred embodiment, the ultra-wideband communication sensor unit may measure at least one of heartbeat information, non-contact respiratory information and movement information of the driver.

In yet another preferred embodiment, the wearable device may be formed in any one of a wristband type, a glasses type and a ring type.

In still yet another preferred embodiment, the additional biometric information signals measured by the wearable device may include at least one of heartbeat information, body temperature information, blood sugar information, pupillary change information, blood pressure information, blood alcohol information and a dissolved oxygen content in blood.

In a further preferred embodiment, the driver biometric information signal measurement method may further include transmitting, by the wearable device, a biometric abnormality event message to a predetermined sever or receiver through short-range communication, if the additional biometric information signals are outside biometric information data ranges set in advance in the storage unit.

In another further preferred embodiment, the driver biometric information signal measurement method may further include executing, by the control module, at least one of restriction of the speed of the vehicle, blinking of emergency lights of the vehicle and guidance of parking of the vehicle, if it is judged that an abnormality event of the measured driver biometric information signals occurs.

In still another further preferred embodiment, the ultra-wideband communication sensor unit may set a security mode of the vehicle according to any one of stopping of the vehicle, turning-off of starting of the vehicle and user setting.

Other aspects and preferred embodiments of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a block diagram illustrating the configuration of a control module of a driver biometric information signal measurement system of a vehicle in accordance with the present invention;

FIG. 2 is a block diagram illustrating the configuration of an ultra-wideband communication sensor unit in accordance with the present invention;

FIG. 3 is a graph illustrating biometric information signals measured according to a respiratory period of a driver in accordance with one embodiment of the present invention;

FIG. 4 is a view illustrating a driver biometric information signal measurement system including a driver wristband type wearable device in accordance with the present invention; and

FIG. 5 is a flowchart illustrating a driver biometric information signal measurement method in accordance with the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents and other embodiments within the spirit and scope of the invention as defined by the appended claims.

The present invention provides technology that may measure biometric information signals of a vehicle driver in real time through an ultra-wideband communication sensor located within a vehicle. Further, noise caused by vibration and noise of the vehicle including the ultra-wideband communication sensor is removed from the biometric information signals of the driver and, thus, driver biometric information having higher accuracy may be measured. Moreover, additional biometric information signals are measured through a wearable device and thus various biometric information of the driver may be provided. Hereinafter, respective elements of a driver biometric information signal measurement system in accordance with the present invention will be described.

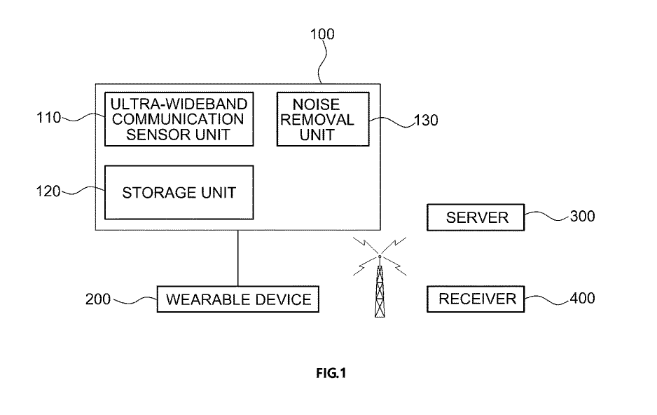

FIG. 1 is a block diagram illustrating measurement of biometric information signals of a driver through an ultra-wideband communication sensor unit in accordance with one embodiment of the present invention.

As exemplarily shown in FIG. 1, a control module 100 is located in a vehicle in accordance with the present invention. The control module 100 may be mounted in the vehicle in an OEM manner and, more particularly, be formed as a module separately installed in the vehicle. Further, the control module 100 may interwork with an electronic control unit (ECU) located in the vehicle and thus perform electronic control of the vehicle, and individual vehicle control may be carried out according to biometric information signals of a driver measured by the control module 100.

The control module 100 includes an ultra-wideband communication sensor unit 110 formed at a position facing a vehicle console or a driver to measure biometric information signals of the driver, a storage unit 120 to store the measured biometric information signals and a noise removal unit 130 to remove noise from the stored biometric information signals.

The ultra-wideband communication sensor unit 110 configured to measure biometric information signals may be regulated by short-range wireless communication technology which realizes ultra-high speed communication at low power over a very wide bandwidth, as compared to a conventional spectrum, and transmit an ultra-wideband communication impulse signal of low output at a comparatively wide frequency spectrum.

As such, the ultra-wideband communication sensor unit 110 measures ultra-wideband communication through signals, and ultra-wideband communication is regulated by short range wireless communication technology which realizes ultra-high speed communication at low power over a very wide bandwidth, i.e., generally at a speed of 100 Mbps or more in a bandwidth of 3.1 to 10.6 GHz, as compared to a conventional spectrum, and transmit a signal of low output at a comparatively wide frequency spectrum. Ultra-wideband communication may have a data transmission rate of hundreds of Mbps to several Gbps within a radius of 10 m. In order to prevent interference with other communication systems, ultra-wideband communication distributes signal energy to a spectrum over a bandwidth of several GHz so as to communicate without interference with other narrow band signals and without regard to frequency, and ultra-wideband communication is strong against noise and has a high transmission rate, small power consumption and low transmission output.

Further, as applied to one embodiment of the present invention, biometric information signals may be measured now through an ultra-wideband radar. This is applied to technology for measuring vibration or a respiratory period of a human body based on characteristics of transmission of information using a short pulse. That is, as an ultra-wideband communication signal, a measurement signal may be transmitted to the human body, i.e., the heart or the chest cavity, and a signal reflected by the human body may be received so that signals from various parts of the human body may be measured and thus response characteristics of the parts of the human body may be measured.

Further, the ultra-wideband communication sensor unit 110 or a wearable device 200 may judge whether or not measured biometric information of the driver of the vehicle coincides with biometric information stored in advance in the storage unit 120 by comparing biometric information signals measured by the ultra-wideband communication sensor unit 110 or the wearable device 200 with the biometric information of the driver, stored in the storage unit 120, during driving of the vehicle. More particularly, a response analysis unit 113 of the ultra-wideband communication sensor unit 110 may execute judgment as to whether or not the current driver of the vehicle coincides with the driver stored in the storage unit 120.

In addition, if the current driver of the vehicle does not coincide with the driver stored in the storage unit 120, a message or a security notification informing that the current driver does not coincide with the driver stored in the storage unit 120 may be transmitted to the ultra-wideband communication sensor unit 110 and the wearable device 200. Further, vehicle control in which driving of the vehicle or number of times of driving of the vehicle is restricted or the vehicle returns to a preset area, may be carried out. Such a driver judgment process may be set or released by a user.

In accordance with one embodiment of the present invention, a heart rate is calculated by measuring the motion period of the chest cavity generated from heart signals. That is, in order to measure a heart rate, a transmitter unit 111 of the ultra-wideband communication sensor unit 110 transmits an ultra-wideband signal, a receiver unit 112 receives a signal reflected by the human body, and the response analysis unit 113 measures the heart rate by calculating an interval between heart signals corresponding to contraction and relaxation of the heart. As such, the present invention provides technology which receives biometric information of a driver in a vehicle through ultra-wideband signals and thus judges whether or not the driver is biometrically abnormal.

In addition, the ultra-wideband communication sensor unit 110 may measure whether or not the driver gets in the vehicle through interworking with door sensors and sheet pressure sensors of the vehicle and motion sensors located in the vehicle. More particularly, the ultra-wideband communication sensor unit 110 may judge whether or not the driver gets in the vehicle by measuring movement of a vehicle steering wheel.

Further, the ultra-wideband communication sensor unit 110 may make a switch to a vehicle security mode according to turning-off of starting of the vehicle, exiting of the driver from the vehicle, the stopped state of the vehicle and a user's setting state. That is, an object moving within a designated distance from the vehicle may be measured through an ultra-wideband communication impulse transmitted from the ultra-wideband communication sensor unit 110 and, if the object approaches the vehicle, a function of outputting a warning message to the driver, blinking emergency lights, and outputting a warning sound may be executed.

As such, if a specific condition, such as a condition that the driver is spaced apart from the vehicle or a condition that the vehicle is stopped, is satisfied, the ultra-wideband communication sensor unit 110 may execute additional functions to prevent vehicle theft and prevent damage to the vehicle by other persons.

The vehicle control module 100 may communicate with the ultra-wideband communication sensor unit 110, the storage unit 120, the noise removal unit 130, and the wearable device 200 through a wired or wireless communication method. The wireless communication method includes a short-range wireless communication method, a long-range wireless communication method or a combination thereof. For example, the short-range wireless communication method may include a Bluetooth, Near Field Communication (NFC) or infrared communication method, the long-range wireless communication may include a mobile communication method, such as 3G, 4G (LTE), Wi-Fi, or WiBro, or a wireless Internet communication method, and these communication methods may be used together according to an arrival distance and communication environments.

In accordance with one embodiment of the present invention, the ultra-wideband communication sensor unit 110 may transmit a measurement signal to the driver's heart or chest cavity through an ultra-wideband impulse signal and receive a signal reflected by the driver's body, thus being capable of measuring response characteristics of a part of the driver's body. Particularly, the ultra-wideband communication sensor unit 110 may measure a respiratory signal of the driver by measuring movement of the driver's chest cavity and measure a driver's heartbeat, thus being capable of providing accurate driver's biometric information.

The measured driver biometric information is stored in the storage unit 120 of the control module 100. The storage unit 120 stores biometric information signals, existing biometric information of the driver, and set values of biometric information data ranges of the driver. As biometric information data of the driver, average values accumulated through learning of the vehicle may be stored or general biometric information data, which is initially set, may be provided. Further, the biometric information data of the driver may be individually set by a user.

If biometric information signals outside the stored biometric information data ranges are measured, not only an abnormal part of the body of the driver but also the abnormal state of an analyzed specific part or whether or not the analyzed part is abnormal may be stored. The storage unit 120 may be a RAM, a ROM, an Electrically Erasable and Programmable Read Only Memory (EEPROM), a Synchronous Dynamic Random Access Memory (SDRAM) or an HDD, but the disclosure of the present invention is not limited to such kinds of storage unit 120.

The noise removal unit 130 of the present invention executes a function of removing noise from biometric information signals received through the ultra-wideband communication sensor unit 110. The biometric information signals received from the ultra-wideband communication sensor unit 110 include vibration generated from an engine of the vehicle, vibration generated due to acceleration/deceleration of the vehicle, and vibration caused by noise generated from the outside or inside of the vehicle. Therefore, in the present invention, a process of removing noise caused by vibration generated from the vehicle through the noise removal unit 130 is executed.

That is, the noise removal unit 130 executes processes of calculating a vibration inflow degree of the vehicle through a vibration sensor, an acceleration and deceleration sensor, a noise sensor, an engine vibration sensor, etc. located within the vehicle, and applying a noise correction value according to the calculated vibration of the vehicle to the biometric information signals received from the ultra-wideband communication sensor unit 110, and thus more accurate driver biometric information signals may be stored.

In addition to the above-described sensors to measure vibration of the vehicle, other units attached to the inside or the outside of the vehicle to measure vibration of the vehicle may be used.

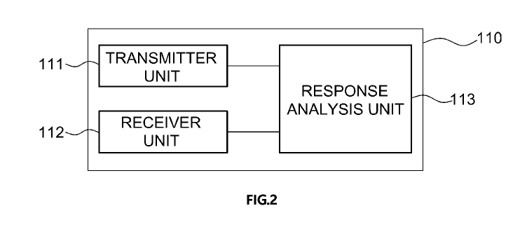

FIG. 2 is a block diagram illustrating the configuration of the ultra-wideband communication sensor unit 110, i.e., the radar transmitter unit 111 to transmit an ultra-wideband communication impulse signal, the receiver unit 112 and the response analysis unit 113.

The ultra-wideband communication sensor unit 110 includes the radar transmitter unit 111 to transmit an ultra-wideband communication impulse signal. The transmitter unit 111 transmits the ultra-wideband communication impulse signal to the driver's chest so as to measure a heartbeat period or a respiratory signal of the driver. The receiver unit 112 executes a function of receiving a signal reflected by the driver's body. Further, the ultra-wideband communication sensor unit 110 includes the response analysis unit 113 which analyzes the received biometric information signal, and measures biometric information of the driver based on the received signal.

If the measured driver biometric informational signal is outside the predetermined biometric information data range stored in the storage unit 120, in order to receive additional biometric information signals, the control module 100 executes communication with the wearable device 200 through a wired or wireless communication method.

If additional biometric information signals are received through the wearable device 200, whether or not the received additional biometric information signals are outside predetermined biometric information data ranges stored in the storage unit 120 is judged again. If the received additional biometric information signals are outside the predetermined biometric information data ranges stored in the storage unit 120, the control module 100 judges that a driver biometric abnormality event occurs.

If the control module 100 communicates with the wearable device 200 through a wireless communication method, the wireless communication method includes a short-range wireless communication method, a long-range wireless communication method or a combination thereof. For example, the short-range wireless communication method may include a Bluetooth, Near Field Communication (NFC) or infrared communication method, the long-range wireless communication may include a mobile communication method, such as 3G, 4G (LTE), Wi-Fi, or WiBro, or a wireless Internet communication method, and these communication methods may be used together according to an arrival distance and communication environments.

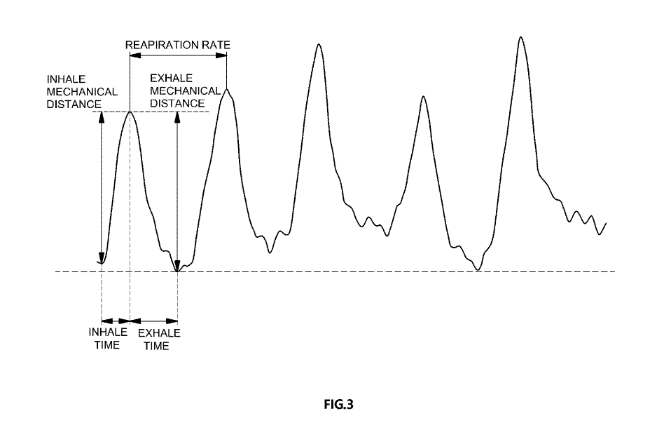

FIG. 3 illustrates a graph illustrating biometric information signals measured according to a respiratory period of the driver through the ultra-wideband communication sensor unit 110 in accordance with one embodiment of the present invention.

As exemplarily shown in FIG. 3, as a result of judgment in one period including inhalation and exhalation of the driver, there is a slight difference between inhalation and exhalation due to vibration of the vehicle.

Therefore, the noise removal unit 130 measures vibration and noise degrees in the vehicle at a point of time when driver biometric information is measured, and corrects the measured driver biometric information, thereby providing a more accurate biometric information signal.

In accordance with one embodiment of the present invention, the wearable device 200 includes all devices which may be formed in a wristband type, a glasses type, a ring type, etc., so as to be attached to the driver's body. Such a wearable device 200 may measure additional biometric information signals, and the additional biometric information signals may include heartbeat information, body temperature information, blood sugar information, pupillary change information, blood pressure information, blood alcohol information, a dissolved oxygen content in blood, etc.

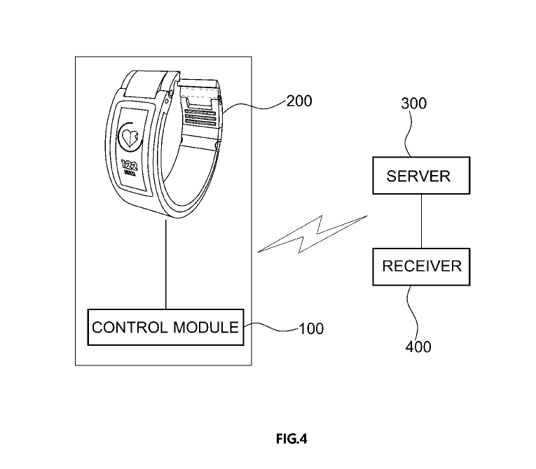

FIG. 4 exemplarily illustrates a wristband type wearable device 200, which the driver may carry or wear, in accordance with one embodiment of the present invention.

The wearable device 200 includes a predetermined display unit located at a position facing the driver and, if biometric information signals measurable by the ultra-wideband communication sensor unit 110 deviate from predetermined biometric information data ranges set in the storage unit 120, measures additional biometric information signals, including heartbeat information, body temperature information, blood sugar information, papillary change information, blood pressure information, blood alcohol information, a dissolved oxygen content in blood and pulse wave information.

As such, the wearable device 200 may measure biometric information signals which are difficult to measure through the ultra-wideband communication sensor unit 110 or are receivable through direct contact with the driver's body, and sensors located in the wearable device 200 may include a piezoelectric sensor, a body temperature sensor, a pulse sensor, a blood flow velocity measurement sensor, a sensor to measure oxygen saturation in blood, etc.

Since power is supplied to the wearable device 200 by a battery, the wearable device 200 requires consumption of a high state of charge of the battery so as to measure biometric information signals for a long period of time. Therefore, in the present invention, the ultra-wideband communication sensor unit 110 measures driver biometric information signals through heartbeat information, non-contact respiratory information and movement information in real time and, in a situation in which additional driver biometric information signals are required, the wearable device 200 measures additional driver biometric information, thereby being capable of effectively managing a battery consumption rate of the wearable device 200.

That is, after driver biometric information signals are measured in real time by the ultra-wideband communication sensor unit 110, if a designated condition is satisfied, additional biometric information signals are measured by the wearable device 200. Here, measurement of driver biometric information signals using the wearable device 200 is executed in consideration of the state of charge of the battery of the wearable device 200.

The wearable device 200 may measure contact-type biometric information signals, which cannot be measured by the ultra-wideband communication sensor 110, and thus provide various body information of the driver if abnormality of the driver's body occurs.

Further, if the measured additional biometric information signals deviate from driver biometric information data ranges set in the storage unit 120, the wearable device 200 transmits the biometric information signals and the wearer's additional biometric information signals and position information to an external server 300. Further, if a designated pressure is applied to an emergency button located at one end of the wearable device 200 or located on a screen of the wearable device 200, the wearable device 200 may transmit the biometric information signals and the position information to the external server 300 or a predetermined receiver 400. That is, according to user setting, the receiver 400 may include a private emergency medical center, a national emergency medical center, an emergency vehicle service center, etc.

In accordance with another embodiment of the present invention, the wearable device 200 may be set to automatically transmit an event message to the receiver 400, if the additional biometric information signals measured by the wearable device 200 deviate from driver biometric information data ranges set in the storage unit 120, i.e., if a biometric abnormality event occurs.

A data communication method of such a wearable device 200 may be any one of ZigBee, infrared communication, ultra-wideband communication, Bluetooth, mobile communication (CDMA, WCDMA, Wi-Fi, LTE or LET-A) and WiBro. More particularly, a wired or wireless terminal located in the control module 100 and a wireless terminal of the wearable device 200 may transmit information through one selected from these methods.

Further, the wearable device 200 may further include an LED unit and a speaker unit. If the wearable device 200 receives a message or an event occurs, the LED unit blinks and thus informs a user of reception of the message and occurrence of the event. Further, the speaker unit executes a function of audibly informing the user of reception of the message and occurrence of the event.

In accordance with one embodiment of the present invention, the wearable device 200 displays the measured additional biometric information signals on the display unit, and informs the user of occurrence of an event through the LED unit and the speaker unit.

The LED unit and the speaker unit of the wearable device 200 judge that a driver's biometric abnormality event occurs and inform the driver of occurrence of the driver's biometric abnormality event, if the measured additional biometric information signals deviate from reference ranges of biometric information data stored in the storage unit 120 of the control module 100. In addition, the wearable device 200 may transmit the biometric information signals and position information, measured by the ultra-wideband communication sensor unit 110 and the wearable device 200, to the external server 300 or the predetermined receiver 400.

Furthermore, if a driver's biometric abnormality event is detected by the ultra-wideband communication sensor unit 110 and the wearable device 200, the control module 100 may blink the emergency lights of the vehicle and restrict the speed of the vehicle. Moreover, in a case of an autonomous vehicle, the vehicle may be guided to pull over onto the shoulder of a road. As described above, obtainment of location of the vehicle in a safety zone and transmission of biometric information signals and position information may be simultaneously or individually carried out.

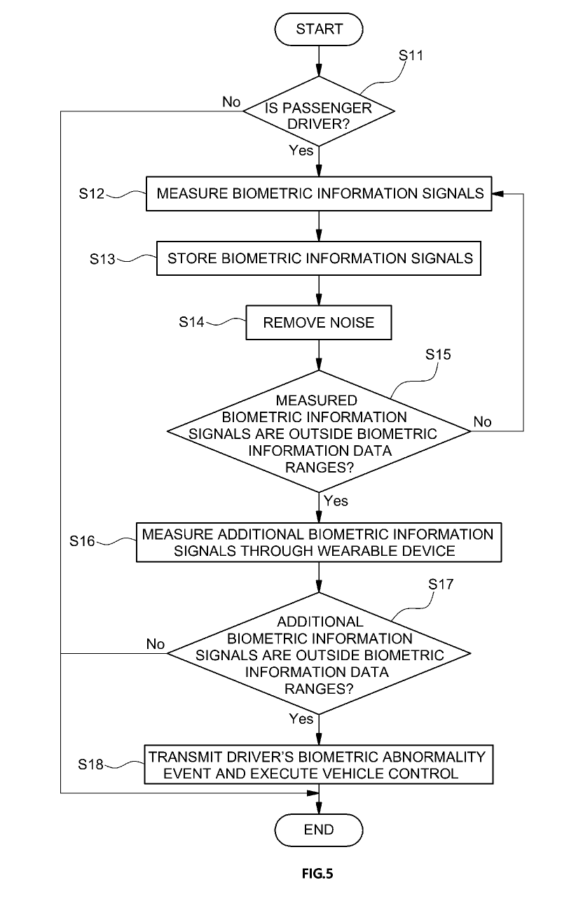

FIG. 5 is a flowchart illustrating a driver biometric information signal measurement method in accordance with the present invention. Hereinafter, with reference to FIG. 5, the driver biometric information signal measurement method will be described.

First, whether or not a driver gets in the vehicle is judged by the ultra-wideband communication sensor unit 110 located in the vehicle (Operation S11) and, upon judging that the driver has got in the vehicle, the ultra-wideband communication sensor unit 110 measures driver biometric information signals (Operation S12). The measured driver biometric information signals may include heartbeat information, non-contact respiratory information and movement information of the driver, etc.

The measured driver biometric information signals are stored in the storage unit 120 (Operation S13), and the noise removal unit 130 corrects the stored biometric information signals according to vibration of the vehicle (Operation S14). The noise removal unit 130 may calculate a correction value according to vibration of the vehicle through the vibration sensor, the acceleration sensor, the noise sensor, etc. of the vehicle, and the biometric information signals stored in the storage unit 120 are corrected based on the calculated correction value.

If it is judged that the corrected biometric information signals deviate from ranges of driver biometric information data predetermined in the storage unit 120 (Operation S15), the wearable device 200 of a wristband type, a glasses type or a ring type measures additional driver biometric information signals (Operation S16). The additional biometric information signals measured by the wearable device 200 may include heartbeat information, body temperature information, blood sugar information, pupillary change information, blood pressure information, blood alcohol information, a dissolved oxygen content in blood, pulse wave information, etc.

If it is judged that the measured additional biometric information signals deviate from ranges of driver biometric information data predetermined in the storage unit 120 (Operation S17), the control module 100 and the wearable device 200 judge that a driver's biometric abnormality event occurs, and transmit the measured biometric information signals and position information to the external server 300 or the predetermined receiver 400 through interworking with a mobile device connected to the control module 100 or the wearable device 200 through a short-range communication method (Operation S18).

Further, if a driver's biometric abnormality event occurs, the control module 100 may restrict the speed of the vehicle, blinks the emergency lights of the vehicle and guide parking of the vehicle so as to secure driving safety of the driver (Operation S18).

As is apparent from the above description, the present invention may have effects as follows.

The present invention provides technology which may measure biometric information of a driver in real time through an ultra-wideband communication sensor located in a vehicle.

Further, the present invention removes noise, caused by vibration of the vehicle including the ultra-wideband communication sensor, from driver biometric information signals, thus being capable of measuring more accurate driver biometric information.

Further, the present invention measures additional biometric information signals through a wearable device, thus being capable of providing various and accurate biometric information of the driver.

Further, the present invention may secure driver safety if a driver's biometric abnormality event occurs by responding to the occurrence, thus improving driving safety of the driver.

Finally, the present invention provides technology which judges whether or not a driver's biometric abnormality event occurs based on predetermined driver biometric information data and transmits occurrence of the driver's biometric abnormality event to a server or a predetermined receiver, thus being capable of optimally responding to the driver's biometric abnormality event.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A driver biometric information signal measurement system comprising:
a control module located in a vehicle, the control module including:
an ultra-wideband communication sensor unit located within the vehicle;
a storage unit configured to store biometric information signals measured by the ultra-wideband communication sensor unit; and
a noise removal unit configured to correct the stored biometric information signals according to vibration of the vehicle, wherein the ultra-wideband communication sensor unit judges whether or not a passenger gets in the vehicle, judges whether or not the passenger is a driver of the vehicle, and measures non-contact type biometric information signals of the driver upon judging that the passenger is the driver; and
a wearable device configured to measure additional contact type biometric information signals of the driver, when the biometric information signals of the driver measured by the ultra-wideband communication sensor unit are outside biometric information data ranges set in advance in the storage unit.

2. The driver biometric information signal measurement system of claim 1, wherein the ultra-wideband communication sensor unit includes:
a transmitter unit configured to transmit an ultra-wideband impulse radio signal;
a receiver unit configured to receive a signal reflected by the driver's body; and
a response analysis unit configured to analyze biometric information from the received signal.

4. The driver biometric information signal measurement system of claim 1, wherein the noise removal unit calculates a correction value according to vibration of the vehicle through a vibration sensor, an acceleration sensor and a noise sensor located in the vehicle and corrects the measured biometric information signals through the calculated correction value.

5. The driver biometric information signal measurement system of claim 1, wherein the ultra-wideband communication sensor unit measures at least one of heartbeat information, non-contact respiratory information and movement information of the driver.

6. The driver biometric information signal measurement system of claim 1, wherein the wearable device is formed in any one of a wristband type, a glasses type and a ring type.

7. The driver biometric information signal measurement system of claim 1, wherein the additional biometric information signals measured by the wearable device include at least one of heartbeat information, body temperature information, blood sugar information, pupillary change information, blood pressure information, blood alcohol information and a dissolved oxygen content in blood.

8. The driver biometric information signal measurement system of claim 1, wherein the wearable device interworks with a mobile device through short-range communication, and transmits a biometric abnormality event message to a predetermined receiver or server through short-range communication, when the additional biometric information signals are outside biometric information data ranges set in advance in the storage unit.

9. The driver biometric information signal measurement system of claim 1, wherein, when it is judged that an abnormality event of the measured driver biometric information signals occurs, the control module executes at least one of restriction of the speed of the vehicle, blinking of emergency lights of the vehicle and guidance of parking of the vehicle.

10. The driver biometric information signal measurement system of claim 1, wherein the ultra-wideband communication sensor unit sets a security mode of the vehicle according to any one of stopping of the vehicle, turning-off of starting of the vehicle and user setting.

11. A driver biometric information signal measurement method comprising:
judging, by an ultra-wideband communication sensor unit located in a vehicle, whether or not a passenger gets in the vehicle and judging whether or not the passenger is a driver of the vehicle;
measuring, by the ultra-wideband communication sensor unit, biometric information signals of the driver, upon judging that the passenger is the driver;
storing the measured driver biometric information signals in a storage unit;
correcting, by a noise removal unit, the stored biometric information signals according to vibration of the vehicle; and
measuring, by a wearable device, additional biometric information signals of the driver, if the driver biometric information signals measured by the ultra-wideband communication sensor unit are outside biometric information data ranges set in advance in the storage unit.

12. The driver biometric information signal measurement method of claim 11, wherein measurement of the biometric information signals of the driver by the ultra-wideband communication sensor unit includes:
transmitting, by a transmitter unit, a ultra-wideband impulse radio signal;
receiving, by a receiver unit, a signal reflected by the driver's body; and
analyzing, by a response analysis unit, biometric information from the received signal.

14. The driver biometric information signal measurement method of claim 11, wherein the noise removal unit calculates a correction value according to vibration of the vehicle through a vibration sensor, an acceleration sensor and a noise sensor located in the vehicle and corrects the measured biometric information signals through the calculated correction value.

15. The driver biometric information signal measurement method of claim 11, wherein the ultra-wideband communication sensor unit measures at least one of heartbeat information, non-contact respiratory information and movement information of the driver.

16. The driver biometric information signal measurement method of claim 11, wherein the wearable device is formed in any one of a wristband type, a glasses type and a ring type.

17. The driver biometric information signal measurement method of claim 11, wherein the additional biometric information signals measured by the wearable device include at least one of heartbeat information, body temperature information, blood sugar information, pupillary change information, blood pressure information, blood alcohol information and a dissolved oxygen content in blood.

18. The driver biometric information signal measurement method of claim 11, further comprising transmitting, by the wearable device, a biometric abnormality event message to a predetermined receiver or server through short-range communication, when the additional biometric information signals are outside biometric information data ranges set in advance in the storage unit.

19. The driver biometric information signal measurement method of claim 11, further comprising executing, by a control module, at least one of restriction of the speed of the vehicle, blinking of emergency lights of the vehicle and guidance of parking of the vehicle, when it is judged that an abnormality event of the measured driver biometric information signals occurs.

20. The driver biometric information signal measurement method of claim 11, wherein the ultra-wideband communication sensor unit sets a security mode of the vehicle according to any one of stopping of the vehicle, turning-off of starting of the vehicle and user setting.
